(19) United States
(12) Patent Application Publication
(10) Pub. No.: US 2006/0169348 A1
(43) Pub. Date: Aug. 3, 2006

(54) Dosage device and method particularly useful for preparing liquid medications

(76) Inventor: Gil Yigal, Gan-Yavne (IL)

Correspondence Address: Martin Moynihan;c/o ANTHONY CASTORINA, SUITE 207, 2001 JEFFERSON DAVIS HIGHWAY, ARLINGTON, VA, 22202, US

(21) Appl. No.: 11/035,727

(22) Filed: Jan. 18, 2005

(51) Int. Cl. B65B 1/04; B65B 3/04; B65B 31/00; B67C 3/00

(52) U.S. Cl. 141/21

(57) ABSTRACT

A dosage device for preparing a predetermined dosage of a liquid substance, particularly a liquid medication, includes: a housing format with a compartment; a cylinder open at one end and received in the compartment; a piston movable within the cylinder and defining a dosage chamber between one side of the piston and the second end of the cylinder for receiving a predetermined dosage of the liquid substance; a dosage fixing assembly movable through the one end of the cylinder and precisely controlled to fix the position of the dosage fixing assembly, and thereby the position of the piston when in contact with the dosage fixing assembly; the dosage fixing assembly when moving through the one end of the cylinder, closing the open end to define a control chamber with the other side of the piston; and a fluid pressure source communicating with the control chamber between the piston and dosage fixing assembly, the fluid pressure source being controllable to increase the pressure in the control chamber to move the piston away from the dosage fixing assembly, and to decrease the pressure in the control chamber to move the piston towards and into contact with the dosage fixing assembly. Also described is a method of preparing a predetermined dosage of a liquid medication substance utilizing the above-described dosage device.

### FIELD AND BACKGROUND OF THE INVENTION

The present invention relates to dosage devices and methods for preparing predetermined dosages of liquid substances. The invention is particularly useful for preparing predetermined dosages of liquid medications for hypodermic delivery, and the invention is therefore described below with respect to such an application.

The market of medicaments for hypodermic delivery is constantly increasing, and with it the demand for hypodermic drug delivery systems. An accepted appliance for hypodermic drug delivery is an automatic injector that provides a number of advantages with respect to problems associated with hypodermic drug delivery: a) It is safe, convenient and easy to operate, which makes it suitable for self administering of medicaments, thus minimizing the patient's dependence on help-givers, reducing the costs, and enhancing the quality of life; b) it facilitates needle retraction at the end of a delivery, which minimizes risk of sticking by a possibly contaminated needle after use; c) it effectively covers the needle so that it is not visible to the patient, which thus reduces needle phobia; and d) it avoids the traumatic experience of self-penetration of the tissue by the user.

Despite its many advantages, the potential use of automatic injectors is severely limited because of the following drawbacks: (a) They have a need for pre-filled drug reservoirs (syringes or cartridges), which need requires drug manufacturers to open a dedicated filling and capping line for pre-filled syringes or cartridges in parallel to the existing filling line for the common vial container; b) the filling process required for pre-filled syringes or cartridges is expensive because of the difficulties of preventing air bubbles during filling and of sterilizing during filling; c) pre-filled syringes are made of glass for storage compatibility, which makes them very expensive; d) pre-filled syringes are of fixed dosage and do not accommodate variable dosage requirements; and e) the piston inside the syringe or cartridge may stick to the barrel during storage and may cause injection mal-functioning.

Some automatic injectors have been developed that transfer a measured dose of medication from a standard vial or container into the injector's container before injecting; however, such injectors generally are awkward to use, and/or unreliable in operation.

Another problem involved in hypodermic injectable medication is insuring shelf life during storage. Many medications are not stable in liquid form and are therefore stored in solid form (e.g. lyophilized drug in powder or paste form). Such medications must therefore be reconstituted with solvents or fluid diluents before use. The reconstitution process, however, is generally very difficult for the users (caregivers or patients) to perform and generally requires a high degree of skill and experience. For example, generally the user has to hold vertically both a vial with the powder drug and a syringe with the diluents, then penetrate the rubber stopper of the vial with the needle of the syringe, and then inject the diluents into the vial at a controlled rate to avoid foaming. Some drugs then require gentle shaking for better dissolution. The reconstituted preparation is finally drawn back into the syringe. This operation requires the user to maintain the needle in the exact depth inside the vial to avoid the risk of drawing air into the syringe or residual drug being retained in the syringe. The reconstituting process also involves the danger of exposure to an unprotected needle tip which may be contaminated or contain medications dangerous to the caregiver.

Devices are known that facilitate reconstituting drugs, but generally they are not completely reliable. Other known devices which enable both the preparation of drugs (e.g. reconstituting and filling a measured dose), and the administration of drugs to a patient, are either very expensive or are complicated and unreliable.

### OBJECTS AND BRIEF SUMMARY OF THE PRESENT INVENTION

An object of the present invention is to provide a novel dosage device and method for preparing predetermined dosages of a liquid substance, which device and method have advantages in some or all of the above respects, and therefore are particularly useful for preparing predetermined dosages of a liquid medication.

According to one aspect of the present invention, there is provided a dosage device for preparing predetermined dosages of a liquid substance, comprising: a housing formed with a compartment; a cylinder open at one end received in the compartment; a piston movable within the cylinder and defining a dosage chamber with the opposite end of the cylinder for receiving a predetermined dosage of a liquid substance; a dosage fixing assembly movable through the one end of the cylinder and defining a control chamber with respect to the piston; and a fluid pressure source communicating with the control chamber between the piston and dosage fixing assembly, the fluid pressure source being controllable to increase the pressure in the control chamber to move the piston away from the dosage fixing assembly, and to decrease the pressure in the control chamber to move the piston towards and into contact with the dosage fixing assembly.

According to another aspect of the present invention, there is provided a dosage device for preparing predetermined dosages of a liquid medication, comprising: a housing having a compartment for receiving a removable cartridge unit including a cylinder open at one end and a piston movable therein, such that the piston defines with the opposite end of the cylinder a dosage chamber for receiving a liquid medication substance; a dosage fixing assembly movable within the one end of the cylinder in sealed engagement to define a control chamber with the piston; and a fluid pressure source communicating with the control chamber between the movable piston and the dosage fixing assembly, the fluid pressure source being controllable to increase the pressure in the control chamber to move the piston away from the dosage fixing assembly, and to decrease the pressure in the control chamber to move the piston towards and against the dosage fixing assembly, and thereby to precisely fix the volume of the dosage chamber.

According to yet another aspect of the present invention, there is provided a dosage device for preparing a predetermined dosage of a liquid substance, comprising: a housing format with a compartment; a cylinder open at one end and received in the compartment; a piston movable within the cylinder and defining a dosage chamber between one side of the piston and the opposite end of the cylinder for receiving a predetermined dosage of a liquid substance; a plunger stem movable through the one end of the cylinder and precisely controlled to fix the position of the plunger stem, and thereby the position of the piston when in contact with the dosage plunger stem; the plunger stem when moving through the one end of the cylinder, closing the open end to define a control chamber with the other side of the piston; and a fluid pressure source communicating with the control chamber between the piston and plunger stem, the fluid pressure source being controllable to increase the pressure in the control chamber to move the piston away from the plunger stem, and to decrease the pressure in the control chamber to move the piston towards and into contact with the plunger stem

According to another aspect of the present invention, there is provided a dosage device for preparing predetermined dosage of a liquid medication, comprising: a housing having a compartment for receiving a removable cartridge unit including a cylinder open at one end and a piston movable therein, such that the piston defines with the opposite end of the cylinder a dosage chamber for receiving a liquid medication substance; a dosage fixing assembly movable through the one end of the cylinder and precisely controlled to fix the position of the dosage fixing assembly, and thereby the position of the piston when in contact with the dosage fixing assembly; the dosage fixing assembly when moving through the one end of the cylinder, closing said open end to define a control chamber with the other side of the piston; and a fluid pressure source communicating with the control chamber between the piston and dosage fixing assembly, the fluid pressure source being controllable to increase the pressure in the control chamber to move the piston away from the dosage fixing assembly, and to decrease the pressure in the control chamber to move the piston towards and into contact with the dosage fixing assembly; the dosage fixing assembly including a fluid passageway therethrough for communicating the fluid pressure source with the control chamber between the piston and dosage fixing assembly.

According to a still further aspect of the present invention, there is provided a method of preparing a predetermined dosage of a liquid substance, comprising: coupling a container of a liquid substance to a device including cylinder having a piston defining a dosage chamber with the cylinder; the device further including a dosage fixing assembly defining a control chamber with the piston; increasing the pressure in the control chamber between the piston and dosage fixing assembly to move the piston away from the dosage fixing assembly and thereby to transfer the air from the dosage chamber into the container to pressurize the container; and decreasing the pressure in the control chamber between the piston and dosage fixing assembly to move the piston towards and into contact with the dosage fixing assembly, and thereby to draw a predetermined volume of the liquid substance from the container into the dosage chamber.

According to yet another aspect of the present invention, there is provided a method of preparing a predetermined dosage of a liquid medication substance, comprising: vertically coupling to a device including a plunger stem, a cylinder having a piston defining a dosage chamber with an upper end of the cylinder; elevating the plunger stem by a motor contained within the device, to enter in sealed engagement through a wide opening of a lower end of the cylinder to define a control chamber inside the cylinder between the plunger stem and the piston; further moving the plunger stem inside the cylinder towards the piston while decreasing the volume of the control chamber and expelling the air from the control chamber to the atmosphere through a passageway in said plunger stem until the plunger stem engages and further moves the piston along the cylinder to a predetermined location defining a measured volume of said dosage chamber; coupling a supply container with a medication substance into the device while forming a pathway between the supply container and the dosage chamber inside the cylinder; connecting the control chamber to a pressure source contained in the device through the passageway included within the plunger stem; increasing the pressure inside the control chamber by the pressure source to drive the piston away from the plunger stem until the piston is stopped at the upper end of the cylinder, while transferring a fluid contents of the measured volume of the dosage chamber into the supply container with the medication substance; and decreasing the pressure inside the control chamber by the pressure source to move the piston towards and into contact with the plunger stem thereby drawing a dosage of a liquid medication substance wherein the volume of the dosage is defined by the predetermined location of the plunger stem.

As will be described more particularly below, such a device and method are particularly applicable in a multi-task automatic system that combines all the capabilities of preparing a predetermined dosage of a liquid medication or other liquid substance including: reconstituting solid compounds of drug with diluents; and/or transferring and measuring a predetermined dosage of a liquid medication drawn from a standard vial container or reconstituted from a plurality of such containers, into a cartridge unit of an automatic injector. Such a multi-task automatic system facilitates one or more of the foregoing tasks with a minimum risk of needle stick, drug contamination, air bubbles, or dosage errors.

While the preferred embodiments of the invention described below illustrate a device for performing one or more of the above-described tasks in an automatic manner, it will be appreciated that the invention could be implemented in devices which perform one or more of such tasks in a manually-controlled, non-automatic manner.

Further features and advantages of the invention will be apparent from the description below.

### BRIEF DESCRIPTION OF THE DRAWINGS

The invention is herein described, by way of example only, with reference to the accompanying drawings, wherein:

FIG. 1 pictorially illustrates one form of dosage device constructed in accordance with the present invention;

FIG. 2 is a sectional view more particularly illustrating the internal structure of the dosage device of FIG. 1;

FIGS. 3-9 illustrate various stages in the operation of the dosage device of FIGS. 1 and 2;

FIGS. 10a and 10b are flow charts illustrating one manner of using the dosage device of FIGS. 1-9;

FIG. 11 is a view generally corresponding to that of FIG. 8 but illustrating several variations in the construction of the dosage device;

FIG. 12 is a view generally similar to that of FIG. 4, but illustrating another variation in the construction of the dosage device;

FIG. 13 is a pictorial illustration of yet another dosage device constructed in accordance with the present invention; and

FIGS. 14 and 15 illustrate different stages in the use of the dosage device of FIG. 13.

It is to be understood that the foregoing drawings, and the description below, are provided primarily for purposes of facilitating understanding the conceptual aspects of the invention and various possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF PREFERRED EMBODIMENTS

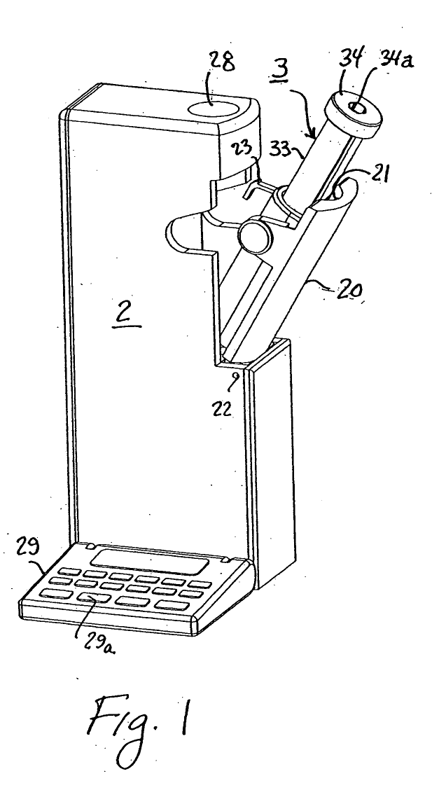

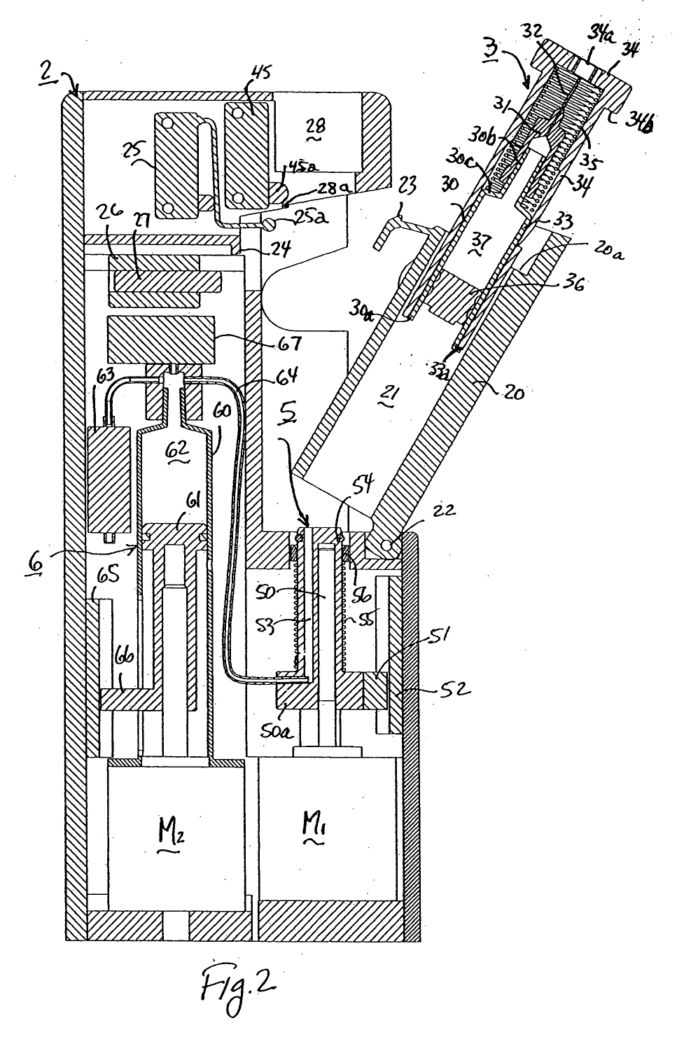

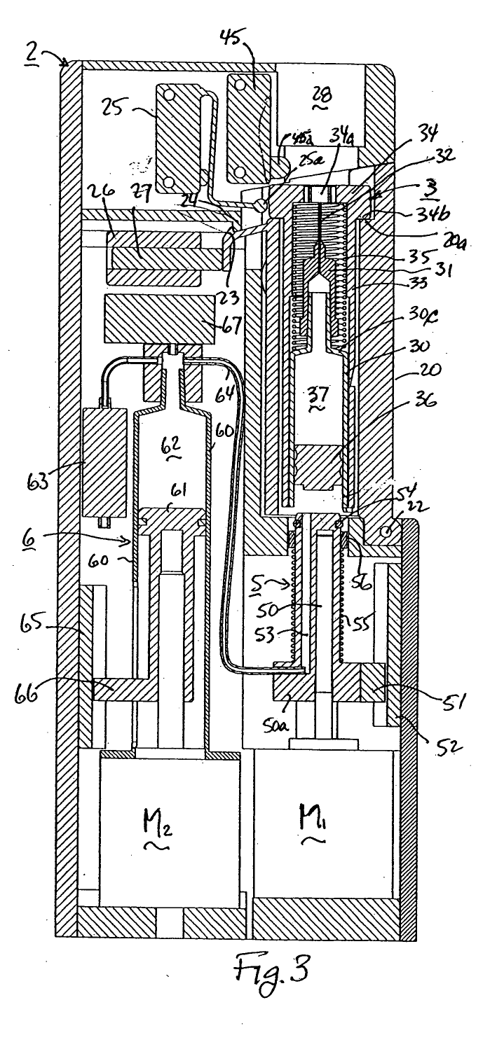

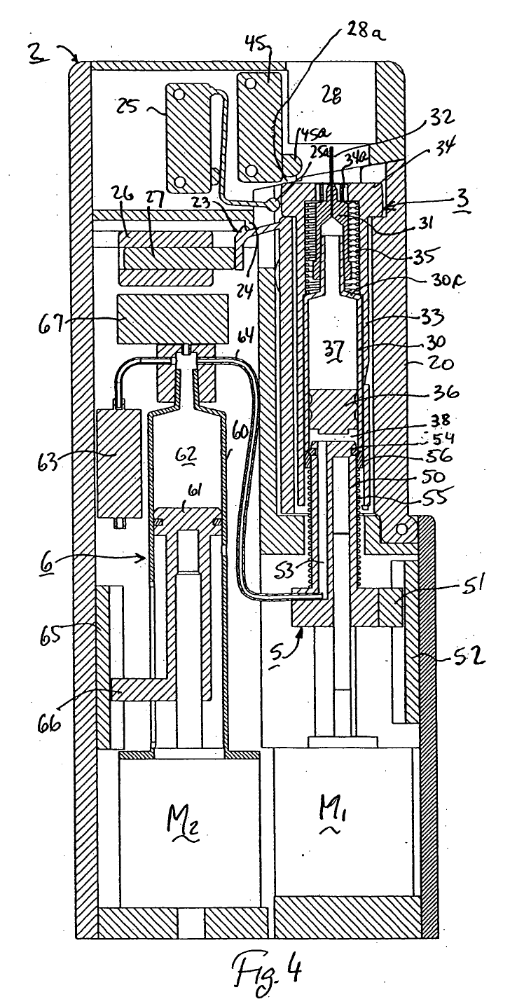

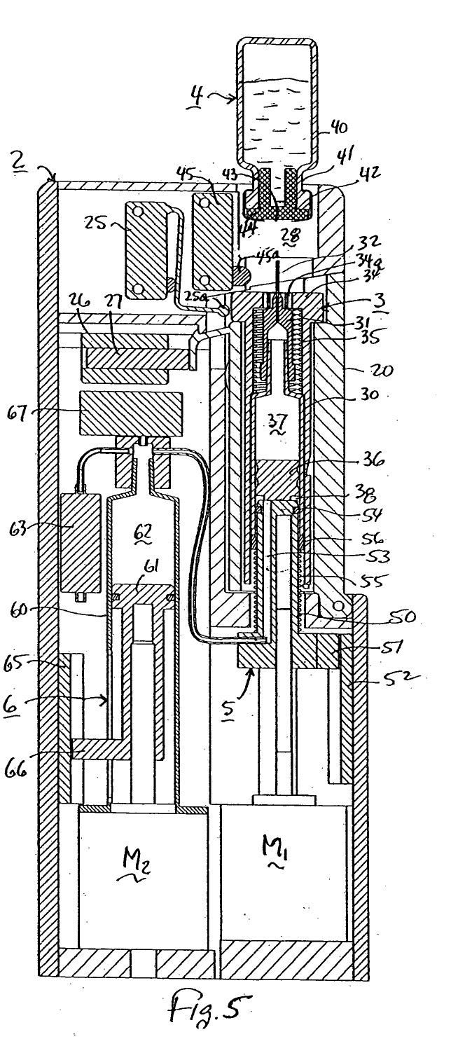

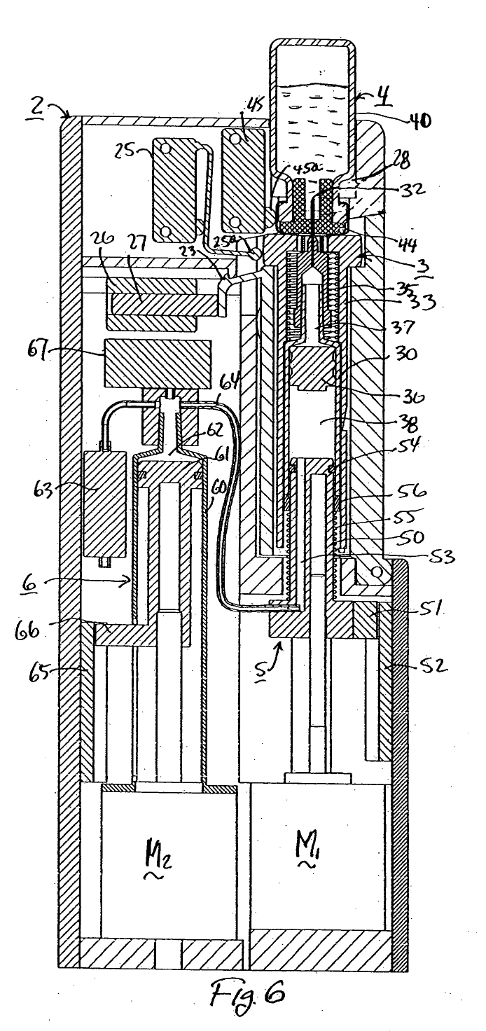

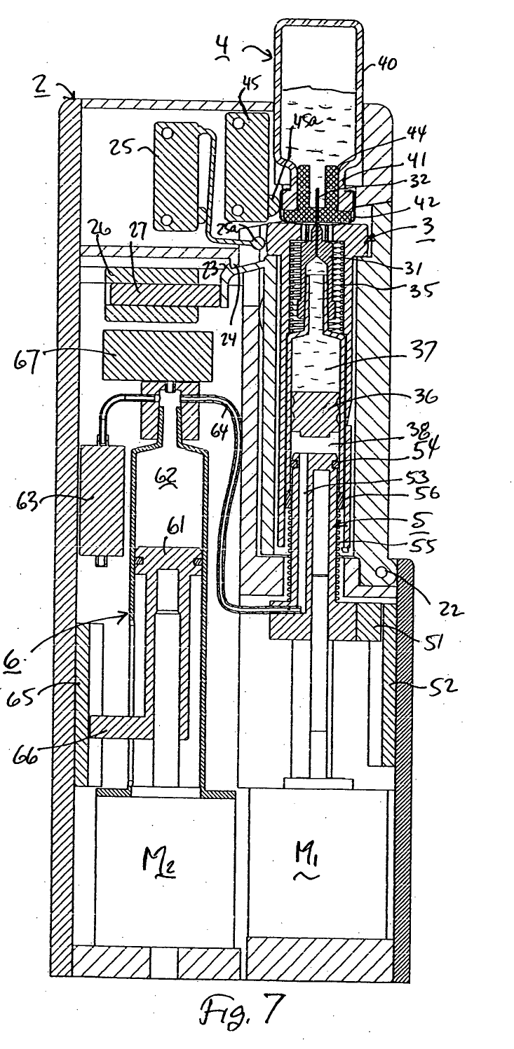

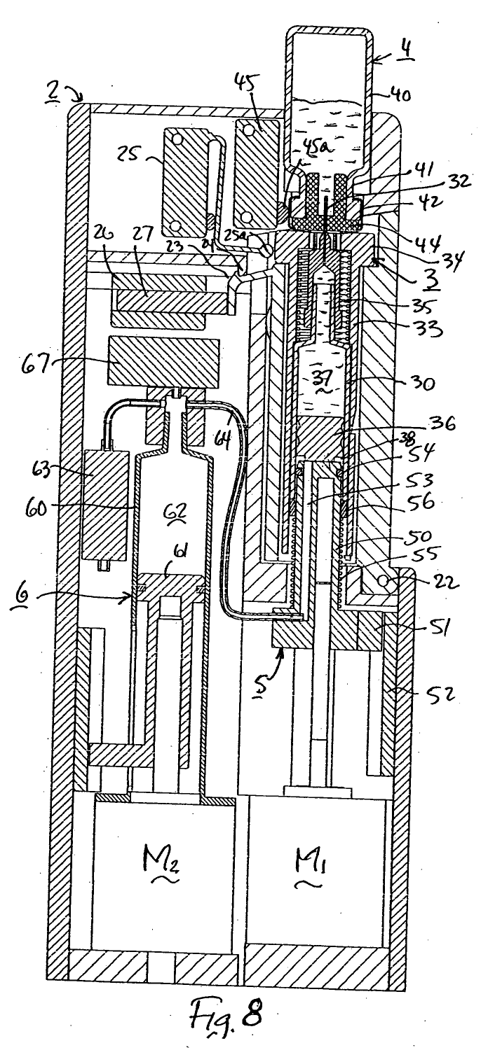

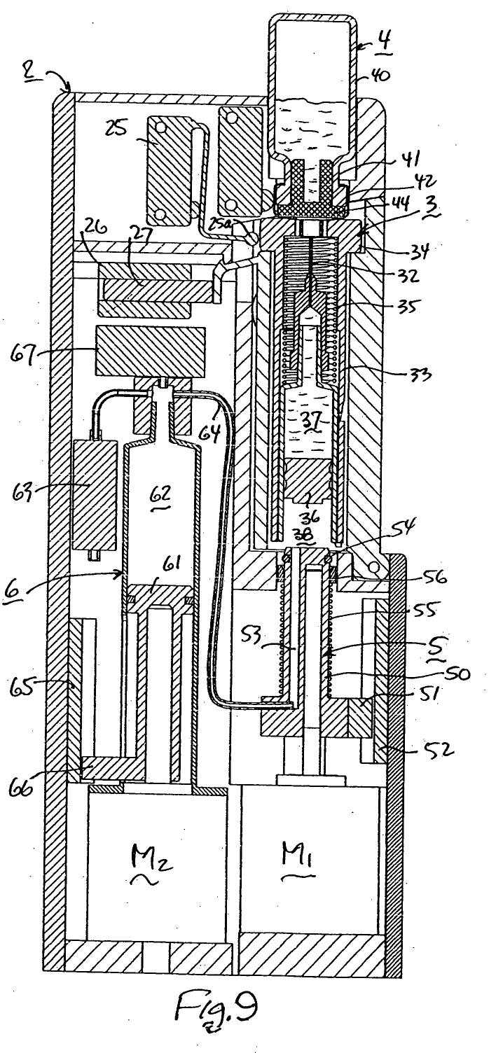

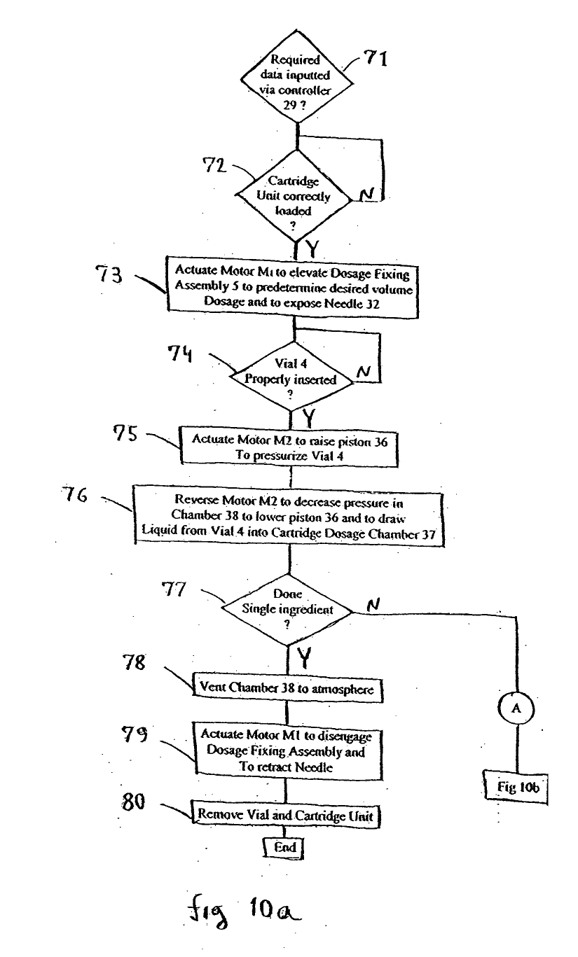

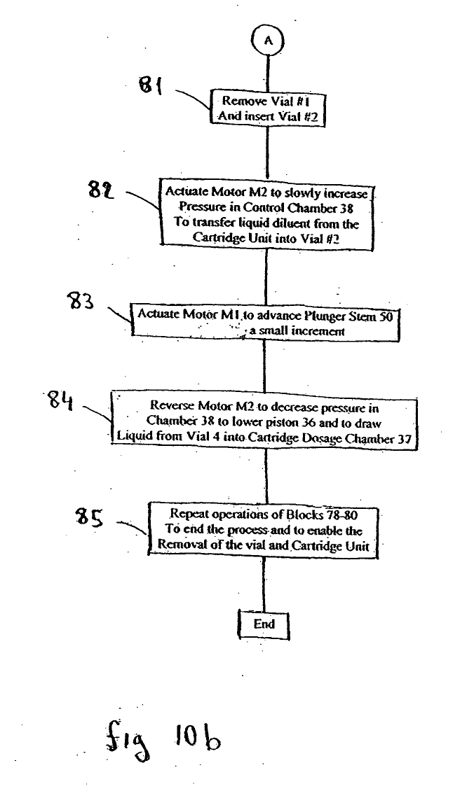

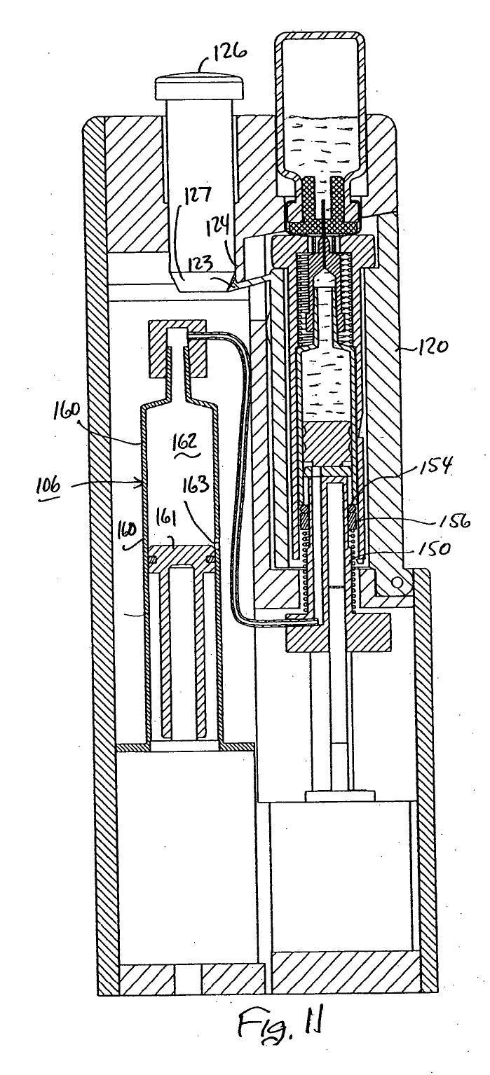

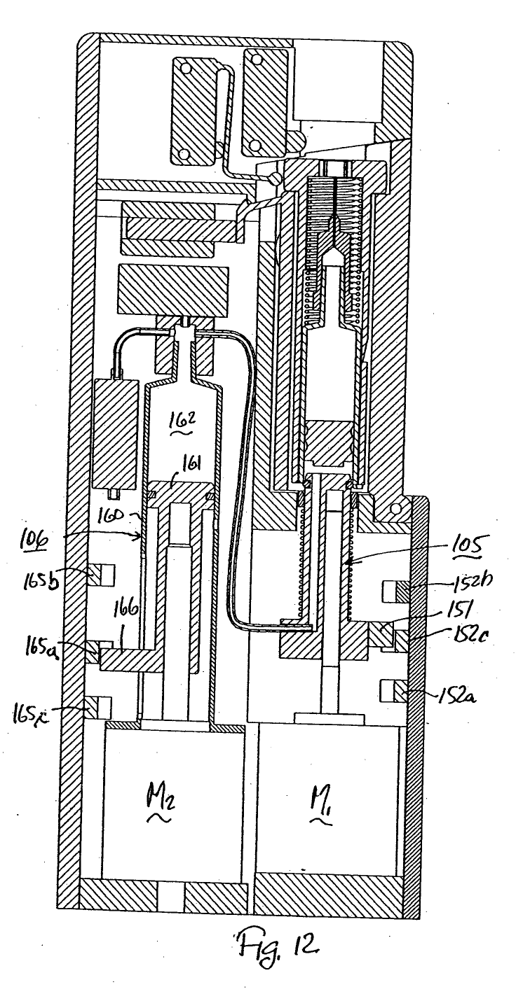

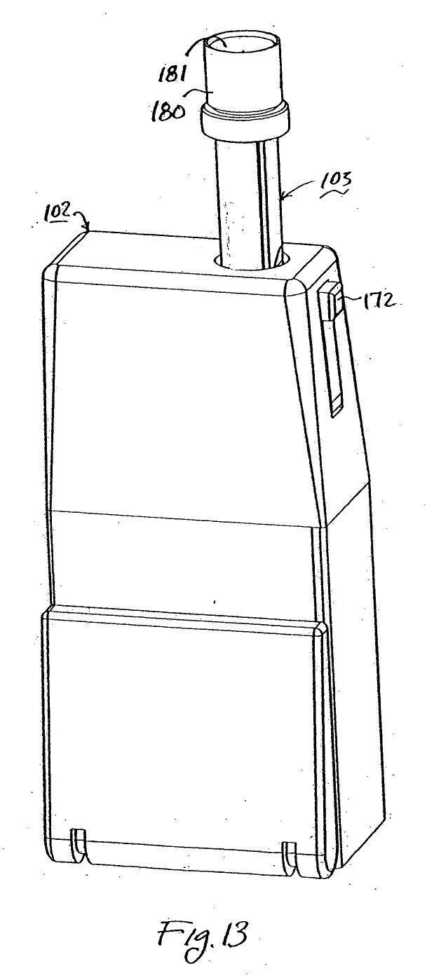

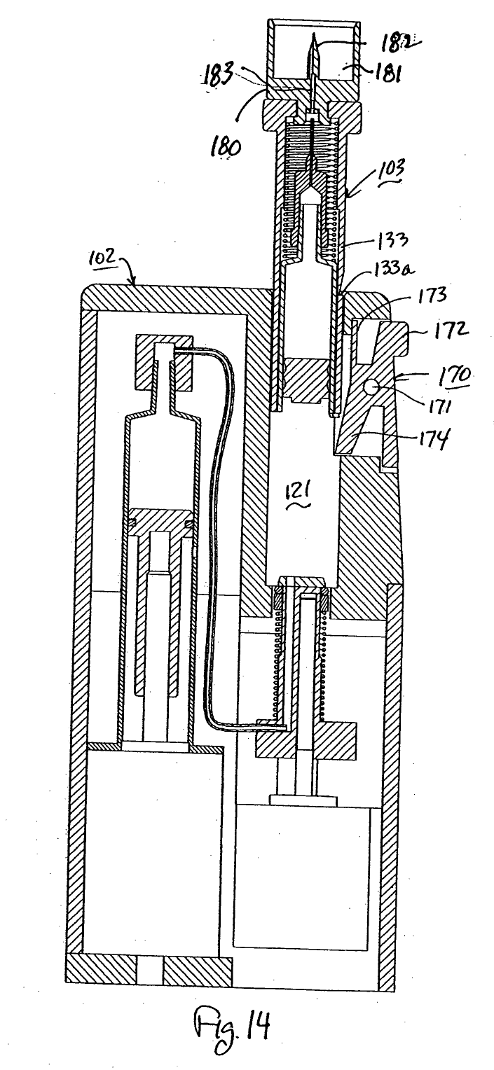

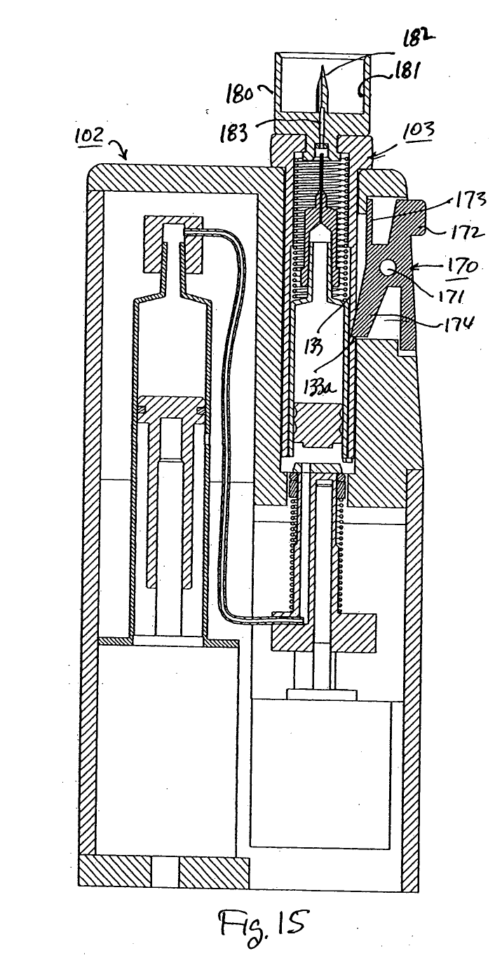

The Dosage Device of FIGS. 1-9

The dosage device illustrated in FIGS. 1-9 includes a housing, generally designated 2, adapted to receive a removable cartridge unit 3 to be used in preparing, and receiving a predetermined dosage of a liquid substance, in this case a liquid medication for hypodermic delivery by means of an automatic injector. For this purpose, housing 2 is formed with a socket 28, described below for receiving a container in the form of a vial 4 (FIGS. 5-9) containing the liquid medication to be loaded into the removable cartridge unit 3. Housing 2 further includes a dosage fixing assembly, generally designated 5 (e.g., FIG. 2), and a controllable source of fluid pressure, generally designated 6, used in the various tasks performed by the dosage device, as will be described more particularly below.

As shown particularly in FIG. 2, housing 2 includes a holder 20 formed with a compartment 21 for removably receiving the cartridge unit 3. Holder 20 is pivotally mounted at 22 to either an open position, shown in FIGS. 1 and 2, for loading or removing the cartridge unit 3, or to a closed position, as shown in FIG. 3, for the preparation of the predetermined dosage of the liquid medication to be loaded into the cartridge unit. A tooth 23 carried by holder 20 is receivable within a retainer clip 24 in housing 2 for retaining the holder in its closed position. A sensor 25 within housing 2 and having a sensor element 25a is actuated by the cartridge unit 3 when holder 20 is in its closed position illustrated in FIG. 3 to enable the device for operation.

Housing 2 further includes a solenoid 26 controlling a plunger 27 which is actuated, upon energization of the solenoid, for releasing cartridge holder 20 from retainer clip 24, to thereby permit the cartridge holder to pivot to its loading/unloading position, as shown for example in FIGS. 1 and 2.

Housing 2 further includes the previously mentioned socket 28 for receiving a vial 4 (FIGS. 5-9) containing a supply of the liquid medication to be loaded into the cartridge unit 3, and a ledge 28a underlying socket 28. In the example described below, the prepared medication is a reconstituted one, prepared from a lyophilized or freeze-dried substance reconstituted by a liquid diluent. In such case, as described more particularly below, socket 28 is used first for receiving a vial containing the liquid diluent, and then for receiving a vial containing the lyophilized or freeze dried substance.

Housing 20 further includes a controller 29 (FIG. 1), including a keyboard 29a, for automatically controlling the operation of the illustrated dosage device, as will also be described more particularly below.

As further seen in FIG. 2, the removable cartridge unit 3 includes a cylinder 30 open at one end, and reduced in diameter at the opposite end, to define a large-diameter section 30a, a small-diameter section 30b, and an annular juncture 30c between the two sections. An end cap 31 carrying a hypodermic needle 32 is applied to section 30b. Cap thus closes that end of cylinder 30 except for needle 32 carried by the cap.

Cartridge unit 3 further includes an outer barrel 33 open at one end 33a, corresponding to end 30a of cylinder 30. Barrel 33 is closed at its opposite end by an enlarged head 34 formed with a center opening 34a in alignment with needle 32, and an undersurface 34b engageable with a ledge 20a in cartridge holder 20. Cylinder 30 is urged inwardly of barrel 33 by a relatively soft spring 35 between the inner surface of barrel end wall 34 and annular juncture 30c of cylinder 30. Spring 35 thus normally maintains cylinder 30 in a retracted position with respect to barrel 33, effectively shrouding needle 32 from view, but permits the cylinder to be moved to an extended position with respect to the barrel, and thereby to expose needle 32, as will be described below.

Cartridge 3 further includes a piston 36 movable within cylinder 30 to define a chamber 37 between the piston and end cap 31 of the cylinder. The opposite side of piston 36 defines a second chamber 38 with dosage fixing assembly 5 during the operation of the device, as will be described below (FIG. 4).

As will also be described below, chamber 37 between piston 36 and end cap 31 is used for measuring a predetermined dosage of the liquid medication substance introduced into the cartridge via hypodermic needle 32, and therefore is referred to below as a dosage chamber; whereas chamber 38 between piston 36 and dosage fixing assembly 5 is used for controlling the position of piston 36, and is therefore referred to below as a control chamber. As also described below, piston 36 is movable by air pressure applied to control chamber 38 between the piston and dosage fixing assembly 5. For this purpose, the fluid pressure source 6 is controlled to apply to control chamber 38 a positive pressure to move the piston towards end cap 31, a negative pressure to move the piston towards and into contact with the dosage fixing assembly 5, or to vent the control chamber to the atmosphere.

Vial 4 containing the liquid medication, or one of the liquid medication components, to be loaded into cartridge unit 3, is more particularly illustrated in FIGS. 5-9. As shown in FIG. 6, for example, it is dimensioned to be received within socket 28 of housing 2, and to be in alignment with hypodermic needle 32 of the cartridge unit 3 when the cartridge holder 20 is in its operative (closed) position.

Vial 4 may be of a conventional construction. It includes a glass container 40 formed with a reduced neck 41 closed by a cap 42 having an opening 43 in alignment with needle 32 when the cartridge unit is in its operative position. Cap 42 further includes a rubber plug 44 which hermetically seals the interior of the vial, but which is piercable by needle 32 passing through opening 43 of cap 42, as will be described more particularly below. The proper insertion of vial 40 into socket 28 is sensed, in the closed condition of holder 20, by sensing element 45a of a sensor 45 carried by the housing 2.

As noted above, dosage fixing assembly 5 is located within housing 2 so as to be in alignment with the cartridge unit 3 in the closed condition of the cartridge holder 20, as shown for example in FIG. 3. During the operation of the device, dosage fixing assembly 5 is movable towards the outer end of cylinder 30 of the cartridge unit 3 and is engageable with or by piston 36 to precisely fix the position of the piston within the cylinder such as to precisely fix the volume of dosage chamber 37 receiving the liquid medication (FIG. 5).

Dosage fixing assembly 5 includes a plunger stem 50 mechanically coupled to a reversible electrical motor M₁ so as to be driven either in the forward direction towards piston 36, or in the reverse direction away from the piston. Plunger stem 50 carries a movable element 51 cooperable with a linear encoder 52 fixed within housing 2 to precisely locate the position of the upper surface of the plunger stem 50 and also to track the movements of the plunger stem.

Plunger stem 50 is further formed with an axial passageway 53 therethrough connected to the controllable fluid pressure source 6 for applying either a positive pressure, a negative pressure, or atmospheric pressure, to control chamber 38 between plunger stem 50 and piston 36. A sealing ring 54, received within an annular groove of the plunger stem, seals this chamber formed when the plunger stem is located within the cartridge cylinder 30.

A spring 55 is interposed between the enlarged base 50a of plunger stem 50, and a ring 56 adjacent to sealing ring 54 at the opposite end of the plunger stem. Spring 55 of dosage fixing assembly 5 is a relatively stronger spring, substantially stronger than the light spring 35 of the cartridge unit 3.

As indicated above, fluid pressure source 6 is controlled to selectively apply a positive pressure, a negative pressure, or atmospheric pressure to the control chamber 38 between plunger stem 50 and piston 36 of the cartridge unit 3. For this purpose, fluid pressure source 6 includes a cylinder 60 fixed within housing 2, and a piston 61 movable within cylinder 60 for controlling the pressure within a pressure chamber 62 defined by piston 61, sometimes referred to below as a pressure-source chamber.

Piston 61 is coupled to a second reversible motor M₂ which drives piston 61 inwardly of cylinder 60 to increase the pressure in chamber 62, or outwardly of the cylinder to decrease the pressure within that chamber. Chamber 62 may also be vented to the atmosphere by a venting valve 63. The pressure within chamber 62 is communicated, via a tube 64 and passageway 53 through plunger stem 50, to the control chamber 38 between the plunger stem and piston 36 of the cartridge unit 3. The movements of piston 61 within cylinder 60 are also controlled and tracked by a movable element 66 carried by piston 61 and cooperable with a linear encoder 65 fixed within housing 2.

A pressure/voltage transducer, shown schematically at 67, measures the pressure within chamber 62, and thereby within control chamber 38 of cartridge unit 3. The measured pressure thus may be used for control purposes, for controlling the velocity of piston 36, and thereby the flow rate of the diluent into the powder drug within a vial to avoid foaming.

Operation (FIG. 10)

One manner will now be described, particularly with reference to the flow chart of FIG. 10, of using the described dosage device for preparing a predetermined dosage of a liquid substance, particularly a liquid medication, and for loading that dosage into the removable cartridge unit 3. In the example described below, the predetermined dosage of medication loaded into the cartridge unit 3 is constituted of a solid substance (e.g., a lyophilized or freeze dried medication) supplied from one vial and mixed with a liquid diluent supplied from another vial. Many such medications are thus provided in separate vials or other containers, e.g., because of storage problems, to be reconstituted at the time of use.

Operation of the dosage device involves control of motor M₁, which controls the dosage fixing assembly 5, and motor M₂, which controls the fluid pressure source 6. Motor M₂ controls the fluid pressure source 6 to drive piston 36 within cylinder 30 of cartridge unit 3 through one or more controlled cycles of operation, during which precise volumes of fluids are transferred between cartridge unit 3 and the supply container, e.g. vial 4, FIG. 5. That is, fluid pressure source 6 produces a controlled pressure applied (via its pressure-source chamber 62) to control chamber 38 for moving piston 36 in the cartridge unit with respect to dosage fixing assembly 5. Dosage fixing assembly 5, in turn, controls the starting/ending positions of each cycle of piston 36 in cylinder 30, which positions determine the initial and final volumes, respectively, of dosage chamber 37 during the one cycle of operation of piston 36. Venting valve 63 is also controlled such that, at the appropriate time during the operation of the device, control chamber 38 may be effectively vented to the atmosphere. The foregoing controls may be effected automatically, if desired, by inputting the appropriate data via the keyboard 29a of controller 29 (FIG. 1).

With the cartridge holder 20 in its open position (FIGS. 1 and 2), a cartridge unit 3 is introduced into compartment 21 and is slid downwardly to its lowermost position within the compartment, wherein the undersurface 34b of barrel head 34 engages ledge 20a of the cartridge holder 20, as shown in FIG. 3. The cartridge holder may then be pivoted to its closed position in which it is retained by clip 24 engaging tooth 23, as also seen in FIG. 3. This closed position of the cartridge holder 20 is sensed by the cartridge holder sensor 25 having a sensor element 25a engageable with barrel head 34 of the cartridge unit 3.

As seen in the flow chart of FIG. 10, the system controller 29 checks to see whether the required data has been inputted via the keyboard controller 29a (block 71), and whether the cartridge holder 20 has been properly closed with a cartridge unit properly loaded therein (block 72). as sensed by sensor 25. This is the condition of the device as illustrated in FIG. 3.

Upon receiving the proper signal from sensor 25, motor M₁ is actuated to elevate dosage fixing assembly 5. At the beginning of this movement, ring 56 of the dosage fixing assembly 5 engages the outer end 30a of the cartridge cylinder 30, and starts to move the cylinder upwardly, while the cartridge barrel 33 is prevented from moving upwardly by the housing ledge 28a underlying the vial socket 28. It will thus be seen that, as shown in FIG. 4, the upward movement of the cylinder, with the barrel restrained against movement, effectively moves the cartridge cylinder 30, and projects needle 32 through opening 34a of the barrel head 34 into socket 28. The forward movement of the cylinder along barrel 33 is permitted by cartridge spring 35, which is relatively soft as compared to the much stronger spring 55 in the dosage fixing assembly 5.

Further upward movement of the dosage fixing assembly 5 brings the plunger stem 50 into contact with piston 36 and moves the piston upwardly until the volume of the dosage chamber 37, between the piston and the cylinder end cap 31, equals the volume of the medication to be loaded into dosage chamber 37 of the cylinder. In addition, during the insertion of the plunger stem into the cylinder, the elastomeric seal 54 seals between the plunger stem and the inner wall of the cylinder to form the control chamber 38. This is the condition of the device as illustrated in FIG. 5 and is represented by block 73 in the flow chart of FIG. 10.

At this point, vial 4 containing the liquid medication to be loaded into the cartridge unit 3 is inserted into socket 28 such that plug 44 of the vial is pierced by the projecting needle 32 of the cartridge unit (FIG. 6). The proper insertion of the vial into socket 28 is sensed by sensing element 45a of sensor 45 (block 74. FIG. 10).

Upon receiving the proper signal from sensor 45, motor M₂ of the fluid pressure source 6 is actuated to move its piston 61 inwardly of cylinder 60, thereby increasing the pressure in the pressure-source chamber 62. This pressure is transferred via tube 64 and passageway 53 of the plunger stem 50 to control chamber 38 between plunger stem 50 and the cartridge piston 36. This causes the cartridge piston 36 to rise, decreasing the volume of dosage chamber 37, and thereby pressurizing the interior of vial 4 via needle 32, (block 75, FIG. 10).

When dosage chamber 37 has been reduced to its minimum volume (FIG. 6), motor M₂ is operated in the reverse direction to move its piston 61 outwardly of cylinder 60, such as to gradually decrease the pressure within the pressure-source chamber 62, and thereby within control chamber 38 between the cartridge piston 36 and the plunger stem 50. This decreased pressure on one side of piston 36 (from control chamber 38), together with the positive pressure on the opposite side of the piston (from dosage chamber 37 and vial 4), moves piston 36 towards plunger stem 50, thereby drawing liquid medication from vial 4 into dosage chamber 37 (FIG. 7), until the piston engages the plunger stem 50. Piston 61 may be controlled to gradually decrease the positive pressure in chamber 38 past zero to a negative value to assure firm seating of piston 36 against plunger stem 50 and thereby to assure the desired dosage to be filled with the medication from vial 4. This is the condition illustrated in FIG. 8, and is represented by block 76 in FIG. 10.

Since plunger stem 50 had been precisely positioned to define the desired volume of the dosage chamber 37, the amount of liquid medication drawn into dosage chamber 37 will thus be exactly equal to the dosage desired to be loaded into the cartridge unit. Since the vial 4 was previously pressurized with the same volume that was later drawn out as liquid medication, this assures that both the vial and the dosage chamber are finally at atmospheric pressure.

If the cartridge unit is to be loaded with a single medication (block 77), then when piston 36 is firmly seated against plunger stem 50, valve 63 is actuated to vent the pressure-source chamber 62, and thereby also the control chamber 38, to the atmosphere (block 78). While chamber 38 is thus vented to the atmosphere, motor M₁ is actuated to move the dosage fixing assembly 5 downwardly to its initial position, whereby spring 35 of the cartridge unit 3 moves the cartridge cylinder 30 downwardly with respect to the cartridge barrel 33. This causes needle 32 to retract into the barrel 33. Since chamber 37 on one side of piston 36 and chamber 38 on the other side of piston 36 are both at atmospheric pressure during the disengagement of the dosage stem from piston 36 and cylinder 30, no forces act upon piston 36 that might cause undesired movement that can change the dose. This is the condition illustrated in FIG. 9, and is represented by block 79 in FIG. 10. The loading operation is completed, and therefore solenoid 26 is actuated to cause its plunger 27 to release tooth 23 from clip 24 (FIG. 2). Vial 4 may then be removed, and the cartridge holder 20 may be pivoted to its open position to permit unloading the cartridge unit containing the predetermined dosage of medication (block 80).

On the other hand, if the liquid medication loaded into the cartridge unit is a liquid diluent to be used in reconstituting a medication in powder or paste form (e.g., a lyophilized drug), the vial with the liquid diluent loaded into the cartridge is replaced by a second vial containing the lyophilized drug, (block 81).

During insertion, the needle pierces the rubber stopper of the drug vial to communicate with the inner contents of the vial. The negative pressure that exists in control chamber 37 (see block 76) is advantageous to balance a vacuum atmosphere that might remain inside the vial (lyophilize process and capping of the vial accurse under vacuum) and thus to prevent high flow suction of diluents from the cylinder 30 into the vial directed onto the powder drug and causing an undesired foaming effect when the second vial is inserted.

The fluid pressure source (motor M₂) is activated to slowly increase the pressure in the control chamber 38 up to a positive pressure for controllably forcing the piston forwardly thereby to transfer the diluents from the cylinder 30 into the vial in a slow and controlled rate to avoid foaming (block 82).

Motor M₁ is activated to advance the plunger stem 50 towards piston 36 in a small increment (block 83).

Motor M₂ is operated in the reverse direction to decrease the pressure within control chamber 38 thereby to move piston 36 towards plunger stem 50, thereby drawing the reconstituted medication from the vial into dosage chamber 37 (block 84). The previous operation of block 83 ensures that the volume of medication withdrawn is somewhat less then the diluent that was previously transferred into the vial. Thus, the vial will always contain a sufficient amount of medication within it such that needle 32 is always immersed in the liquid medication to prevent the passage of air into the cartridge dosage chamber 37.

The operations of blocks 78-80 are repeated for ending the process and enabling the removal of the cartridge unit gradually loaded with the predetermined dosage of the reconstituted medication (block 85).

After the operation of block 82 wherein the liquid diluent within dosage chamber 37 of the cartridge unit 3 has been transferred to vial 4, if desired the vial may be removed and shaken to thoroughly mix the two ingredients within the vial. Vial 4 may then be re-inserted into socket 28 for proceeding with operations 83-85; or if desired, the process may be ended with the reconstituted medication remaining in the vial.

It will thus be seen that the movements of piston 36 within the cartridge unit 3 effect the transfer of the liquids and/or gases between the vial and the cartridge unit in both directions. Such movements controlled by controlling the pressure differences on the opposite sides of piston 36. These pressure differences may be closely controlled to effect the desired rate of transfer between the cartridge and the vial, and also to provide sufficient force to the piston to overcome the friction between the piston and the cartridge cylinder 30.

It will also be seen that the limits of the movements of piston 36 are precise, physical limits. Thus, the limit in the forward direction is the juncture section 30c of cylinder 30 between its two end sections 30a, 30b and the limit in the rearward direction is plunger stem 50. The latter limit can be precisely fixed, as desired, by controlling motor M₁. Piston 61 of the fluid pressure 6, which controls the pressure within control chamber 38 of the cartridge unit, may also be precisely controlled by motor M₂. Both motors may be controlled either by an open-loop control system (e.g., by stepper motors) or if more precise control is desired, by a closed-loop feedback control system (e.g., optical encoders).

Such a control system may be used, not only for accurately positioning the plunger stem 50 and piston 61, respectively, but also for accurately controlling the velocity of their movements. The velocity of movement of piston 36 may also be controlled to provide the needed rate of transfer of the respective materials between the cartridge unit 3 and the vial 4, taking into consideration the various parameters which may affect the transfer rate, e.g., the volume of the respective vial, the quantity of its contents to be transferred, the viscosity of its contents, the pressure within the vial in its sealed condition, etc.

A better control over the velocity of piston 36 is achieved by a combination of measuring the pressure in the pressure source system (e.g. by mean of the voltage/pressure transducer 67), and the velocity of piston 61 of the pressure source system. This is important mainly for controlling the rate of transferring diluent into a vial with a lyophilized drug in order to avoid foaming.

The above method of controlling the piston inside the cylinder eliminates the need of physically coupling to the piston during the filling process and uncoupling at the end of the process, and is especially advantageous when the above cylinder is part of a cartridge unit of an automatic injector wherein no plunger rod is coupled to the back of the piston for manipulating the piston.

Some Variations and Modifications (FIGS. 11-15)

FIGS. 11-15 illustrate a number of possible variations in the dosage device of FIGS. 1-9. To facilitate understanding, those elements in FIGS. 11-15 corresponding to elements in FIGS. 1-9 are identified by the same reference numerals except increased by “100”.

According to one variation illustrated in FIG. 11, the cartridge unit holder 120, retained in its pivoted closed position by tooth 123 engageable with a projection 124 of the housing, is releasable to its open position by a push button 126 having a conical end 127 engageable with tooth 123 and effective, when the push button is pressed downwardly, to release the tooth from projection 124.

According to a second variation in FIG. 11, the sealing ring 154, corresponding to sealing ring 54 in the FIGS. 1-10 embodiment, is not seated with an annular groove of plunger stem 150, but rather is slidably carried around the outer surface of the plunger stem, in abutting relationship to the plastic ring 156.

According to a third variation in FIG. 11, the fluid pressure source 106, instead of including a venting valve (63) for venting the pressure-source chamber 162 to the atmosphere, includes a cylinder 160 formed with a venting opening 163 located so as to be effective to vent the interior of pressure-source chamber 162 to the atmosphere at the proper time.

In all other respects, the dosage device illustrated in FIG. 11 is constructed and operates in the same manner as described above with respect to FIGS. 1-10.

FIG. 12 illustrates a device involving simpler controls for motor M₁ controlling the dosage fixing assembly 105 and motor M₂ controlling the fluid pressure source 106. Thus, instead of using an encoder for controlling each motor, each motor is controlled to detect three distinct positions. Thus, motor M₁ driving the dosage fixing assembly 105 is controlled by three fixed sensors 152a, 152b and 152c, cooperable with position element 151 carried by the dosage fixing assembly 105. Sensor 152a may define the home position of the dosage fixing assembly 105; sensor 152b may define the position of the dosage fixing assembly for introducing a one-half portion of the liquid medication; and sensor 152c may define the position of the dosage fixing assembly for introducing a full-portion of the liquid medication into the cartridge.

Motor M₂ controlling the position of piston 161 of the fluid pressure source 106 may be controlled by position finger 166 carried by the piston and the three sensors 165a, 165b, 165c, carried by the housing. Sensor 165a may define the lower limit of piston 161 providing the lower pressure; sensor 165b may define the higher limit of the piston providing the higher pressure and sensor 165c may define the venting position of the piston.

FIGS. 13-15 illustrate a modification wherein the housing compartment receiving the removable cartridge unit 103 is not in a holder pivotally mounted to the main section of the housing, as in FIGS. 1-9, but rather is in the main section of the housing 102 as shown by compartment 121 in FIG. 14. For this purpose, the outer barrel 133 of the removable cartridge unit 103 is formed with a notch, as shown at 133a, cooperable with a manual operator member 170 pivotally mounted at 171 to the housing 102. Manual operator 170 includes a thumb element 172 normally urged to its outer position shown in FIG. 14 by an elastic leaf 173 engageable with a ledge of the housing to seat a locking element 174 of operator 170 into notch 133a after the cartridge unit 103 has been manually inserted into housing compartment 121, as shown in FIG. 15. The cartridge unit 103 is releasable from the housing by pressing thumb element 172 to pivot locking element 174 out of notch 133a when the cartridge unit is to be removed from the housing, as shown in FIG. 14.

Another change in the embodiment of FIGS. 13-15 is that the socket for receiving the vial (e.g., socket 28 for vial 4, FIGS. 5-9) is carried, not directly by the housing, but rather by an adaptor 180 coupled to the cartridge 103. As shown particularly in FIGS. 14 and 15, adaptor 180 is formed with a socket 181 for receiving the vial, a spike 182 for piercing rubber plug of the vial, and with a passageway 183 passing through the spike and aligned with the needle of cartridge unit for receiving the needle in the extended position of the needle. Such an adaptor, which would generally be disposable after one-time use, eliminates the risk of damaging the needle tip during the piercing of the plug which closes the vial especially when more than one vial is involved in the process.

In all other respects, the device of FIGS. 13-15 is constructed the same, and operates in the same manner, as described above with respect to FIGS. 1-10.

While the invention has been described with respect to several preferred embodiments, it will be appreciated that these are set forth merely for purposes of example, and that many other variations, modifications and applications of the invention may be made.

What is claimed is:

1. A dosage device for preparing a predetermined dosage of a liquid substance, comprising:
a housing formed with a compartment;
a cylinder open at one end received in said compartment;
a piston movable within said cylinder and defining a dosage chamber with the opposite end of the cylinder for receiving a predetermined dosage of a liquid substance;
a dosage fixing assembly movable through said one end of the cylinder and defining a control chamber with respect to said piston; and
a fluid pressure source communicating with said control chamber between the piston and dosage fixing assembly, said fluid pressure source being controllable to increase the pressure in said control chamber to move the piston away from said dosage fixing assembly, and to decrease the pressure in said control chamber to move the piston towards and into contact with said dosage fixing assembly.

2. The device according to claim 1, wherein said dosage fixing assembly includes a fluid passageway therethrough for communicating said fluid pressure source with said control chamber between said piston and dosage fixing assembly.

3. The device according to claim 1, wherein said piston and cylinder are parts of a removable cartridge unit removably received in said compartment.

4. The device according to claim 3, wherein said compartment is pivotally mounted to said housing to an operative position aligning the removable cartridge unit with said dosage fixing assembly, and to a loading/unloading position to load or unload.

5. The device according to claim 1, wherein said dosage fixing assembly is movable within said one end of the cylinder by an electrical motor controllable to precisely fix the position of the dosage fixing assembly, and thereby the position of the piston when in contact with the dosage fixing assembly.

6. The device according to claim 1, wherein said fluid pressure source includes a second piston movable within a second cylinder to define a pressure-source chamber communicating with said control chamber between said first-mentioned piston and said dosage fixing assembly in said first-mentioned cylinder; and wherein said pressure-source chamber also includes a venting outlet for selectively venting said control chamber to the atmosphere.

7. The device according to claim 6, wherein said second piston is movable within said second cylinder by a motor coupled to said second piston.

8. The device according to claim 1, wherein said piston and cylinder are parts of a removable cartridge unit removably received in said compartment; and wherein said removable cartridge unit is sized for receiving in said dosage chamber a predetermined dosage of a liquid substance.

9. The device according to claim 8, wherein said removable cartridge unit further includes:
a needle at said opposite end of the cylinder for receiving the liquid substance into said dosage chamber, and/or for delivering a fluid from said dosage chamber;
an outer barrel enclosing said opposite end of the cylinder and formed with an end wall having an opening therethrough aligned with said needle;
and a spring between said barrel end wall and said cylinder urging said cylinder and said needle to a retracted position, but movable to an extended position exposing said needle.

10. The device according to claim 9, wherein said housing further includes a socket for receiving a vial adjacent to and in alignment with said needle in the extended position with respect to said barrel.

11. A dosage device for preparing predetermined dosages of a liquid medication, comprising:
a housing having a compartment for receiving a removable cartridge unit including a cylinder open at one end and a piston movable therein, such that the piston defines with the opposite end of the cylinder a dosage chamber for receiving a liquid medication substance;
a dosage fixing assembly movable within said one end of the cylinder in sealed engagement to define a control chamber with said piston;
and a fluid pressure source communicating with said control chamber between said movable piston and said dosage fixing assembly, said fluid pressure source being controllable to increase the pressure in said control chamber to move the piston away from the dosage fixing assembly, and to decrease the pressure in said control chamber to move the piston towards and against said dosage fixing assembly, and thereby to precisely fix the volume of said dosage chamber.

12. The device according to claim 11, wherein said dosage fixing assembly includes a fluid passageway therethrough for communicating said fluid pressure source with said control chamber between said piston and dosage fixing assembly.

13. The device according to claim 11, wherein said removable cartridge unit further includes:
a needle at said opposite end of the cylinder for receiving a liquid medication substance into said dosage chamber, and/or for delivering the fluid substance from said dosage chamber;
an outer barrel enclosing said opposite end of the cylinder and formed with an end wall having an opening therethrough aligned with said needle;
and a spring between said barrel end wall and said cylinder urging said needle to a retracted position shrouded by said barrel, but movable to an extended position exposing said needle.

14. The device according to claim 13, wherein said housing further includes a socket for receiving a vial adjacent to and in alignment with said needle in the extended position of said needle.

15. The device according to claim 11, wherein said dosage fixing assembly is movable within said one end of the cylinder by an electrical motor controllable to precisely fix the position of the dosage fixing assembly, and thereby the position of the piston when in contact with the dosage fixing assembly.

16. The device according to claim 11, wherein said fluid pressure source includes a second piston movable within a second cylinder to define a pressure-source chamber communicating with said control chamber between said first-mentioned piston and said dosage fixing assembly in said first-mentioned cylinder; and wherein said pressure-source chamber also includes a venting outlet for selectively venting said control chamber to the atmosphere.

17. A dosage device for preparing a predetermined dosage of a liquid substance, comprising:
a housing format with a compartment;
a cylinder open at one end and received in said compartment;
a piston movable within said cylinder and defining a dosage chamber between one side of the piston and the opposite end of the cylinder for receiving a predetermined dosage of a liquid substance;
a plunger stem movable through said one end of the cylinder and precisely controlled to fix the position of the plunger stem, and thereby the position of the piston when in contact with the plunger stem; said plunger stem when moving through said one end of the cylinder, closing said open end to define a control chamber with the other side of said piston;
and a fluid pressure source communicating with said control chamber between the piston and plunger stem, said fluid pressure source being controllable to increase the pressure in said control chamber to move the piston away from said plunger stem, and to decrease the pressure in said control chamber to move the piston towards and into contact with said plunger stem.

18. The device according to claim 17, wherein said plunger stem includes a fluid passageway therethrough for communicating said fluid pressure source with said control chamber between said piston and plunger stem.

19. The device according to claim 17, wherein said piston and cylinder are parts of a removable cartridge unit removably received in said compartment.

20. The device according to claim 19 wherein said removable cartridge unit is sized for receiving in said dosage chamber a predetermined dosage of a liquid substance.

21. The device according to claim 17, wherein said plunger stem is part of a dosage fixing assembly which is movable with alignment to the cylinder axis by an electric motor.

22. The device according to claim 21, wherein said dosage fixing assembly further include an annular elastomeric ring to seal between said open end of the cylinder and said plunger stem when moving through said one end of the cylinder for hermetically seal said control chamber.

23. The device according to claim 21, wherein said dosage fixing assembly further include a flexible annular support which urge said open end of the cylinder to forward said cylinder up to a limit when said dosage fixing assembly is moving into contact with said cylinder.

24. The device according to claim 17, wherein said fluid pressure source includes a second piston movable within a second cylinder to define a pressure-source chamber communicating with said control chamber between said first-mentioned piston and said plunger stem in said first-mentioned cylinder; and wherein said fluid pressure-source also includes a venting outlet for selectively venting said control chamber to the atmosphere.

25. The device according to claim 22, wherein said second piston is movable within said second cylinder by a motor coupled to said second piston.

26. The device according to claim 22, wherein said removable cartridge unit further includes:
a needle at said opposite end of the cylinder for receiving the liquid substance into said dosage chamber, and/or for delivering a fluid from said dosage chamber;
an outer barrel enclosing said opposite end of the cylinder and formed with an end wall having an opening therethrough aligned with said needle;
and a spring between said barrel end wall and said cylinder urging said cylinder and said needle to a retracted position, but movable to an extended position exposing said needle.

27. The device according to claim 24, wherein said housing further includes a socket for receiving a vial adjacent to and in alignment with said needle in the extended position of said needle.

28. The device according to claim 19, wherein said compartment is pivotally mounted to said housing to an operative position aligning the removable cartridge unit with said dosage fixing assembly, and to a loading/unloading position to load or unload said cartridge unit for said compartment.

29. A dosage device for preparing predetermined dosages of a liquid medication, comprising:
a housing having a compartment for receiving a removable cartridge unit including a cylinder open at one end and a piston movable therein, such that the piston defines with the opposite end of the cylinder a dosage chamber for receiving the liquid medication substance;
a dosage fixing assembly movable through said one end of the cylinder and precisely controlled to fix the position of the dosage fixing assembly, and thereby the position of said piston when in contact with the dosage fixing assembly; said dosage fixing assembly when moving through said one end of the cylinder, closing said open end to define a control chamber with the other side of said piston;
and a fluid pressure source communicating with said control chamber between the piston and dosage fixing assembly, said fluid pressure source being controllable to increase the pressure in said control chamber to move the piston away from said dosage fixing assembly, and to decrease the pressure in said control chamber to move the piston towards and into contact with said dosage fixing assembly;
said dosage fixing assembly including a fluid passageway therethrough for communicating said fluid pressure source with said control chamber between said piston and dosage fixing assembly.

30. The device according to claim 27, wherein said removable cartridge unit further includes;
a needle at said opposite end of the cylinder for receiving a liquid medication substance into said dosage chamber, and/or for delivering a fluid substance from said dosage chamber;
an outer barrel enclosing said opposite end of the cylinder and formed with an end wall having an opening therethough aligned with said needle;
a spring between said barrel end wall and said cylinder urging said cylinder and said needle to a retracted position, but movable to an extended position exposing said needle.
and an adaptor aligned with said barrel end wall, said adaptor having a socket for receiving a vial and a central hollow spike in alignment with the interior of said vial when connected to said socket, said adaptor being further aligned with said barrel end wall to receive said needle in the extended position of said needle such that said adaptor forms a passageway between said needle and said vial.

31. The device according to claim 27 wherein said removable cartridge unit is sized for receiving in said dosage chamber a predetermined dosage of a liquid medication component.

32. The device according to claim 27, wherein said dosage fixing assembly is movable within said one end of the cylinder by an electrical motor.

33. The device according to claim 27, wherein said fluid pressure source includes a second piston movable within a second cylinder to define a pressure-source chamber communicating with said control chamber between said first-mentioned piston and said dosage fixing assembly in said first-mentioned cylinder; and wherein said pressure-source chamber also includes a venting outlet for selectively venting said control chamber to the atmosphere.

34. The device according to claim 27, wherein said second piston is movable within said second cylinder by a motor coupled to said second piston.

35. A method of preparing a predetermined dosage of a liquid medication, comprising:
vertically coupling to a device including a plunger stem, a cylinder having a piston defining a dosage chamber with an upper end of said cylinder;
elevating said plunger stem by a motor included in said device, to enter in sealed engagement through a wide opening of a lower end of said cylinder to define a control chamber inside said cylinder between said plunger stem and said piston;
further moving said plunger stem inside said cylinder towards said piston while decreasing the volume of said control chamber and expelling the air from said control chamber to the atmosphere through a passageway included within said plunger stem until said plunger stem engages and further moves said piston along said cylinder to a predetermined location defining a measured volume of said dosage chamber;
coupling a supply container with a medication substance into said device while forming a pathway between said supply container and said dosage chamber inside said cylinder;
connecting said control chamber to a pressure source contained in said device through said passageway in said plunger stem;
increasing the pressure inside said control chamber by said pressure source to drive said piston away from said plunger stem until said piston is stopped at said upper end of said cylinder, while transferring a fluid contents of said measured volume of said dosage chamber into said supply container with said medication substance;
and decreasing the pressure inside said control chamber by said pressure source to move said piston towards and into contact with said plunger stem, thereby drawing a dosage of a liquid medication substance wherein the volume of the dosage is defined by said predetermined location of said plunger stem.

36. The method according to claim 35, wherein said medication substance within said supply container is a liquid medication substance and said fluid contents of the measured volume of said dosage chamber is air that pressurizes the interior of said supply container when transferred into said supply container such that when said dosage of said liquid medication substance is transferred from said supply container into said dosage chamber, the interior of said supply container is retained at the initial pressure.

37. The method according to claim 36, wherein after said dosage of liquid medication substance is drawn into said dosage chamber, said pressure source is disconnected from said control chamber to vent said control chamber to the atmosphere through said passageway.

38. The method according to claim 37, wherein after said control chamber is vented to the atmosphere, said plunger stem is moved out of said cylinder by said motor, and wherein said cylinder is part of a cartridge unit initially received within said device in an empty state of said cylinder, and is eventually removed from said device with said cylinder loaded with said predetermined dosage of said liquid medication substance.

39. The method according to claim 36, wherein after said predetermined volume of said liquid medication substance is drawn into said dosage chamber, a second container containing a second medication substance is applied to communicate with said dosage chamber, and wherein said pressure source is again connected to said control chamber and increases the pressure inside said control chamber to drive said piston away from said plunger stem to said upper end of said cylinder while transferring said predetermined volume of liquid medication substance from said dosage chamber into said second container for mixing said second medication substance with said first liquid medication substance.

40. The method according to claim 39, wherein after said predetermined volume of said liquid medication substance is transferred into said second container, said plunger stem is shifted by said motor in a small increment towards said upper end of said cylinder.

41. The method according to claim 40, wherein after said plunger stem is shifted towards said upper end of said cylinder, the pressure inside said control chamber is again decreased by said pressure source to again move said piston towards and into contact with said plunger stem and thereby to draw a predetermined dose of the mixed liquid medication from said second container into said dosage chamber.

42. The method according to claim 41, wherein after said dosage of said mixed liquid medication substance is drawn into said dosage chamber, said pressure source is disconnected from said control chamber to vent said control chamber to the atmosphere through said passageway.

43. The method according to claim 42, wherein after said control chamber is vented to the atmosphere, said plunger stem is moved out of said cylinder by said motor, and wherein said cylinder is part of a cartridge unit initially received within said device in an empty state of said cylinder, and is eventually removed from said device with said cylinder loaded with said predetermined dosage of said mixed liquid medication substance.
